(19) United States
(12) Patent Application Publication
(10) Pub. No.: US 2025/0227007 A1
(43) Pub. Date: Jul. 10, 2025

(54) LIGHT-WEIGHT SOCKET NETWORKING FOR VIRTUAL NETWORK FUNCTIONS

(71) Applicant: Cisco Technology, Inc., San Jose, CA (US)

(72) Inventors: Ralph Schmieder, Karlsruhe (DE); Joseph Michael Clarke, Cary, NC (US)

(21) Appl. No.: 18/408,842

(22) Filed: Jan. 10, 2024

(51) Int. Cl. H04L 12/46; H04L 49/00; H04L 49/25; H04L 69/16

(52) U.S. Cl. CPC H04L 12/4641; H04L 49/25; H04L 49/70; H04L 69/162

(57) ABSTRACT

A method comprises: by a computer device configured with an operating system that implements an Internet Protocol (IP) stack for communicating with an external network, creating a virtual network to include: virtual network devices respectively hosted in containers such that each virtual network device respectively includes an application, a container IP stack, and domain sockets; and a switch fabric to communicate with the domain sockets; and by the virtual network devices, exchanging application data with each other through the switch fabric using read and write operations to and from the domain sockets of the virtual network devices, without involving the IP stack of the operating system.

### TECHNICAL FIELD

The present disclosure relates to using domain sockets in virtual network devices for forwarding network traffic.

### BACKGROUND

Processes running in containers (e.g., in Linux® operating system namespaces) typically communicate with the outside world using host operating system kernel network interfaces (referred to as “host kernel network interfaces”). The host kernel network interfaces typically use technologies such as virtual Ethernet (Veth) pairs, tunnels, or other Linux specific network interface methods. Traditional container networking using Veth pairs, tunnels, or bridges by which the container exchanges data with the outside world (e.g., external networks) involve the host kernel network interfaces because the kernel creates and manages (i.e., “owns”) the host kernel network interfaces. Therefore, the kernel is “in the way” during the data exchanges. This may result in traffic being blocked due to kernel firewall rules and unwanted filtering of traffic due to low-level forwarding restrictions. Also, the operating system kernel likes to source traffic by itself and, if unwanted, this behavior should be explicitly turned off.

### BRIEF DESCRIPTION OF THE DRAWINGS

FIG. 1 is a diagram of an example network environment in which light-weight socket networking of virtual network functions may be implemented, according to an example embodiment.

FIG. 2 is an illustration of data forwarding between virtual network devices using a programmable switch fabric of a virtual network of the network environment, according to an example embodiment.

FIG. 3 is an illustration of an internal process running inside of a container that hosts a virtual network device or function views domain sockets in a namespace of the container vs. how an external process running outside of the container views the domain sockets, according to an example embodiment.

FIG. 4 is a flowchart of an example method of light-weight socket networking of virtual network devices, according to an example embodiment.

FIG. 5 illustrates a hardware block diagram of a computing device that may perform functions associated with operations performed in the embodiments presented herein, according to an example embodiment.

### DETAILED DESCRIPTION

### Overview

In an embodiment, a method comprises: by a computer device configured with an operating system that implements an Internet Protocol (IP) stack for communicating with an external network, creating a virtual network to include: virtual network devices respectively hosted in containers such that each virtual network device respectively includes an application, a container IP stack, and domain sockets; and a switch fabric to communicate with the domain sockets; and by the virtual network devices, exchanging application data with each other through the switch fabric using read and write operations to and from the domain sockets of the virtual network devices, without involving the IP stack of the operating system.

### Example Embodiments

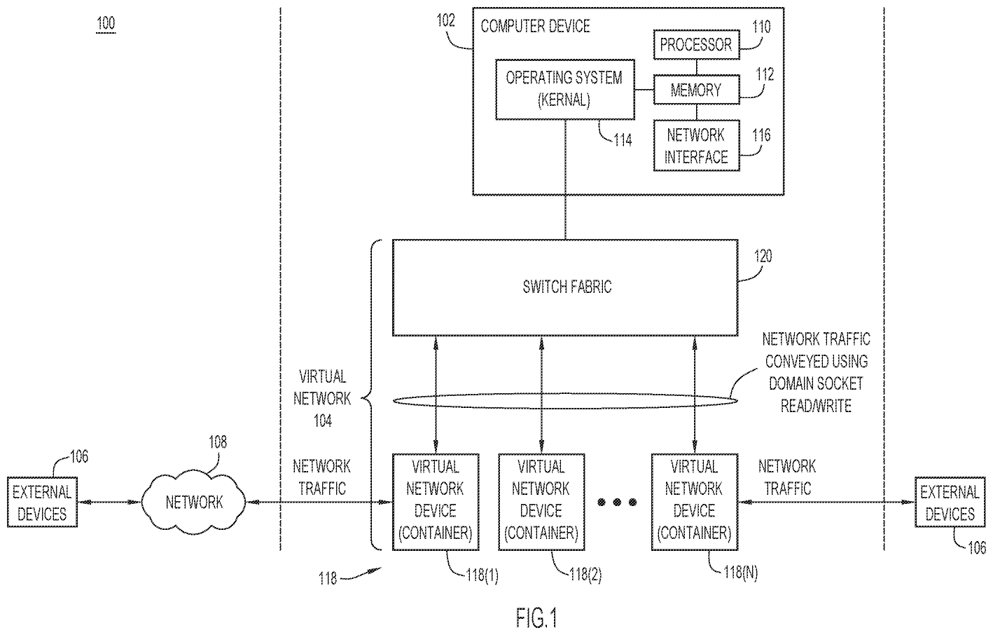

FIG. 1 is a diagram of an example network environment 100 in which light-weight socket networking of virtual network functions may be implemented according to embodiments presented herein. Network environment 100 includes a computer device 102 (e.g., a server) configured to host or implement a virtual network 104, and external devices 106 configured to communicate with the computer device and the virtual network as hosted by the computer device. In a non-limiting example, virtual network 104 may simulate an actual deployed network. In another example, virtual network 104 may serve as an extension to the deployed network. External devices 106 may be connected to computer device 102 over an external network 108 and/or over a cable, such as an Ethernet cable. External network 108 may include one or more wide area networks (WANs), such as the Internet, or over one or more local area networks (LANs).

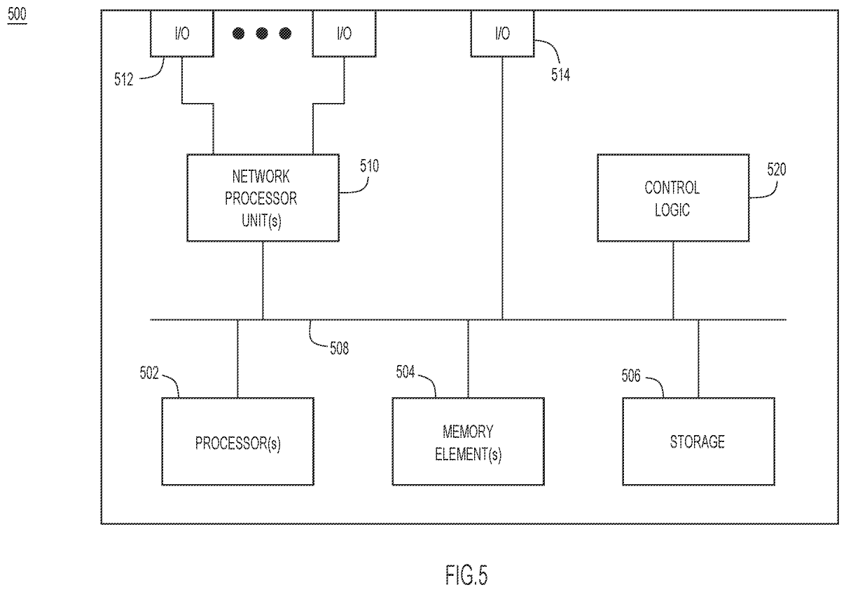

Computer device 102 includes a processor 110, a memory 112 that includes an operating system (OS) kernel 114, and a network interface 116. In the example of FIG. 1, computer device 102 may be a Linux-based computer device and OS kernel 114 may include a Linux kernel. For example, OS kernel 114 may include Cisco IOS® on Linux (IOL). Embodiments presented herein are described in the context of a Linux based computer system by way of example, only. It is understood that the embodiments may be implemented in any non-Linux based environment. Computer device 102 is described below in further detail in connection with FIG. 5.

Computer device 102 creates or instantiates virtual network 104 to include virtual network devices 118(1)-118(N) (also referred to as “virtual network functions”), such as routers, switches, and the like. Virtual network devices 118(1)-118(N) (collectively referred to as “virtual network devices 118” or “containerized network devices”) may be hosted on separate or individual containers instantiated by computer device 102, for example. Computer device 102 may instantiate the containers using any known or hereafter developed technology and technique, such as Docker, for example. Each container is configured to execute one or more applications that implement a corresponding network function, such as a router, a switch, or a portion thereof. The containers may host virtual machines that implement the virtual network devices.

Computer device 102 also instantiates virtual network 104 to include a switch fabric 120 that is programmable and that serves as an interconnect between virtual network devices 118. That is, virtual network devices 118 communicate with each other through switch fabric 120. At a high level, switch fabric 120 serves a programmable switch board that is controlled via application programming interface (API) calls (or other known mechanisms) to interconnect selected ones of virtual network devices 118 as desired (i.e., to connect the selected virtual network devices to each other). In an example, switch fabric 120 may also include virtual network devices. Virtual network devices 118 forward network traffic (e.g., data packets or data frames) between each other through switch fabric 120 in accordance with embodiments presented herein and in accordance with known or hereafter developed communication protocols, such as the Internet Protocol (IP) suite (e.g., a transmission control protocol (TCP)/IP (TCP/IP) stack). The network traffic (e.g., data packets/data frames) may originate from virtual network devices 118, or may originate from external devices 106. According to the embodiments, virtual network devices 118 use domain sockets (e.g., Unix domain sockets (UDSs)) to exchange the network traffic with each other through switch fabric 120, as described in further detail below. Unix domain socket types include, but are not limited to, (i) a first socket type “SOCK_STREAM,” which is a stream-oriented socket used with TCP, for example, and (ii) a second socket type “SOCK_DGRAM,” which is a datagram-oriented socket used with the user data protocol (UDP), for example. The first socket type “SOCK_STREAM” is employed with the TCP/IP stack examples presented herein, although the second socket type “SOCK_DGRAM” may be used in other examples that employ the UDP.

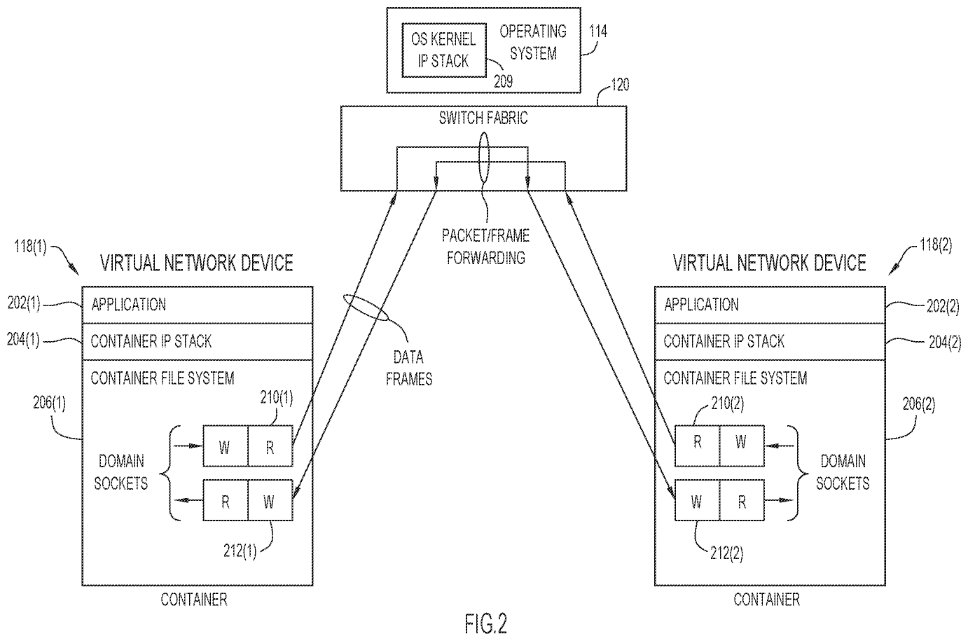

FIG. 2 is an illustration of example data forwarding between virtual network devices 118(1) and 118(2) through switch fabric 120. In the example of FIG. 2, virtual network device 118(1) is implemented as a first container that hosts internal processes including an application 202(1), a custom or container IP stack 204(1) (also referred to as a “virtual IP stack”), and a container file system 206(1) that includes domain sockets 210(1) and 212(1) (e.g., Unix domain sockets) through which the virtual network device communicates directly with switch fabric 120. The processes in the container for virtual network device 118(1) use domain sockets 210(1) and 212(1) as write and read sockets, respectively. That is, the processes write to and read from domain sockets 210(1) and 212(1), respectively. Conversely, switch fabric 120 reads from and writes to domain sockets 210(1) and 212(1), respectively, as described below.

Similarly, virtual network device 118(2) is implemented as a second container that hosts internal processes to include an application 202(2), a container IP stack 204(2), and a container file system 206(2) that includes domain sockets 210(2) and 212(2) (e.g., Unix domain sockets) through which the virtual network device communicates directly with switch fabric 120. The processes in the container for virtual network device 118(2) use domain sockets 210(2) and 212(2) as write and read sockets, respectively. That is, the processes write to and read from domain sockets 210(2) and 212(2), respectively. Conversely, switch fabric 120 reads from and writes to domain sockets 210(2) and 212(2), respectively, as described below.

Container file system 206(1) (and its domain sockets) resides in a namespace of the container that hosts virtual network device 118(1), and container file system 206(2) (and its domain sockets) resides in a namespace of the container that hosts virtual network device 118(2). Container file systems 206(1) and 206(2) are represented in a directory of a host file system of OS kernel 114, such that the directory is accessible to switch fabric 120 to enable the switch fabric to write and read to and from the domain sockets.

OS kernel 114 may also include an OS kernel IP stack 209 employed by the OS kernel to perform network communication with external devices. OS kernel IP stack 209 is separate and distinct from container IP stacks 206(1) and 206(2). OS kernel IP stack 209 operates independently of the container IP stacks.

The aforementioned components of virtual network device 118(2) are configured similarly to those of virtual network device 118(1). Accordingly, the ensuing description of virtual network device 118(1) shall suffice for virtual network device 118(2).

Application 202(1) may be any application that generates and exchanges data (e.g., application data) with application 202(2) through/using container IP stack 204(1), domain sockets 210(1) and 212(1), and switch fabric 120. The applications may include, for example, user applications, such as meeting collaboration applications (e.g., Webex), Internet browsers, positioning applications, and the like, that generate, operate on, and exchange, user application data.

Container IP stack 204(1) (also referred to as a “TCP/IP” stack) may include an application layer (e.g., hypertext transfer protocol (HTTP) layer), a transport layer (e.g., a TCP layer), an Internet layer (e.g., an IP layer to encapsulate application data into an IP packet), and a link layer (e.g., an Ethernet protocol layer to encapsulate the IP packet into an Ethernet frame). Container IP stack 204(1) may perform additional network processing, such as traffic shaping, rate limiting, and the like.

Domain sockets 210(1) and 212(1) may be implemented as separate/individual files that exist in a namespace of the container that hosts virtual network device 118(1). Each file includes a set of memory read (R)/write (W) permissions, and receives timestamps for memory writes to or reads from the file. When computer device 102 (e.g., OS kernel 114) instantiates the container for virtual network device 118(1), the container creates domain socket 210(1), and switch fabric 120 creates domain socket 212(1). In the example of FIG. 2, the processes of the container for virtual network 118(1) do not have visibility outside of the container namespace (e.g., cannot reach outside of the container namespace), and thus do not have memory read or write access beyond domain sockets 210(1) and 212(1). On the other hand, switch fabric 120 can perform memory reads from and writes to domain sockets 210(1) and 212(1) (e.g., can reach into the container namespace), respectively.

Accordingly, the processes of virtual network device 118(1) write data frames to domain socket 210(1), and switch fabric 120 reads the data frames from the domain socket. In the reverse direction, switch fabric 120 writes data frames to domain socket 212(1), and the processes of virtual network device 118(1) read the data frames from the domain socket. In this way, virtual network device 118(1) and switch fabric 120 exchange data frames with each other using domain sockets 210(1) and 212(1), as described further below.

Assume application 202(1) of virtual network device 118(1) originates (application) data destined for application 202(2) of virtual network device 118(2). Application 202(1) sends the data to container IP stack 204(1). The layers of container IP stack 204(1) convert the data to a data frame (e.g., encapsulate the data in an IP packet and then encapsulate the IP packet in an Ethernet frame) and then write the data frame that conveys the data to domain socket 210(1).

Switch fabric 120 reads the data frame from domain socket 210(1), and then writes the data frame (as read from domain socket 210(1)) to domain socket 212(2) of virtual network device 118(2). In doing so, switch fabric 120 transparently passes or forwards the data frame from virtual network device 118(1) to virtual network device 118(2), without otherwise processing the data frame. In virtual network device 118(2), container IP stack 206(2) reads the data frame from domain socket 212(2), recovers the data from the data fame (e.g., decapsulates the Ethernet frame and the IP packet), and provides the recovered data to application 202(2). The above described data exchange through switch fabric 120 does not involve OS kernel IP stack 209.

Assume application 202(2) of virtual network device 118(2) originates (application) data destined for application 202(1) of virtual network device 118(1). Application 202(2) sends the data to container IP stack 204(2). Container IP stack 204(2) encapsulates the data in a data frame, and then writes the data frame to domain socket 210(2). Switch fabric 120 reads the data frame from domain socket 210(2), and writes the data frame (as read from domain socket 210(2)) to domain socket 212(1) of virtual network device 118(1). In virtual network device 118(1), container IP stack 204(1) reads the data frame from domain socket 212(1), decapsulates the data frame to recover the data, and provides the recovered data to application 202(1). The above described data exchange does not involve OS kernel IP stack 209.

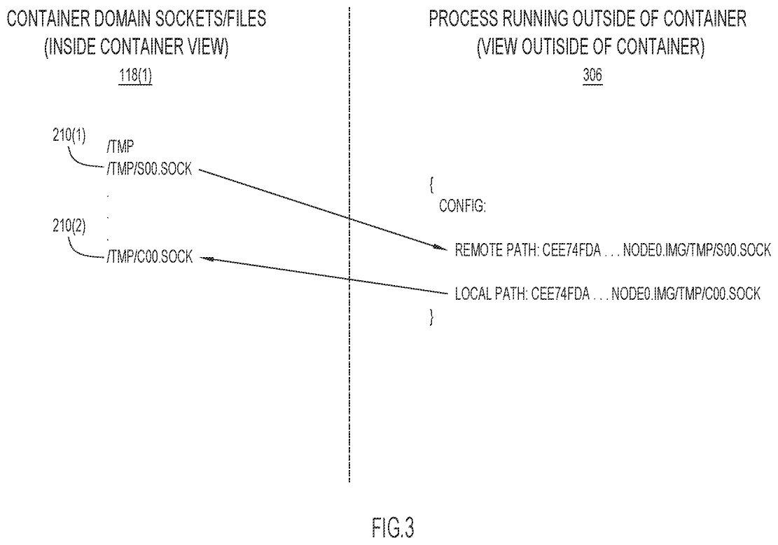

FIG. 3 is an illustration of how an internal process (e.g., a user application, container IP stack, and so on) running inside of the container that hosts virtual network device 118(1) views domain sockets 210(1) and 212(1) in the namespace of the container vs. how an external process 306 (e.g., switch fabric 120) running outside of the container views the domain sockets. On the left side of FIG. 3, domain sockets 210(1) and 212(2) include sockets/TMP/S00.SOCK and/TMP/C00.SOCK (e.g., temporary (TMP) files) stored in container file system 206(1). Container file system 206(1) is represented in a directory of a larger host file system for OS kernel 114 that is accessible to external process 306 (e.g., to switch fabric 120), but the internal process of the container only sees the sockets (and not outside of the sockets) because the sockets are created in the namespace of the container (which limits the reach of the internal process to the container).

Thus, the internal process can write to and read from sockets/TMP/S00.SOCK and/TMP/C00.SOCK, respectively. Also, external process 306 (e.g., a code snippet on switch fabric 120) can read from and write to sockets/TMP/S00.SOCK and/TMP/C00.SOCK, respectively. Essentially, switch fabric 120 can reach into the container namespace to execute writes and reads to and from the sockets, but the container cannot reach outside of the container namespace.

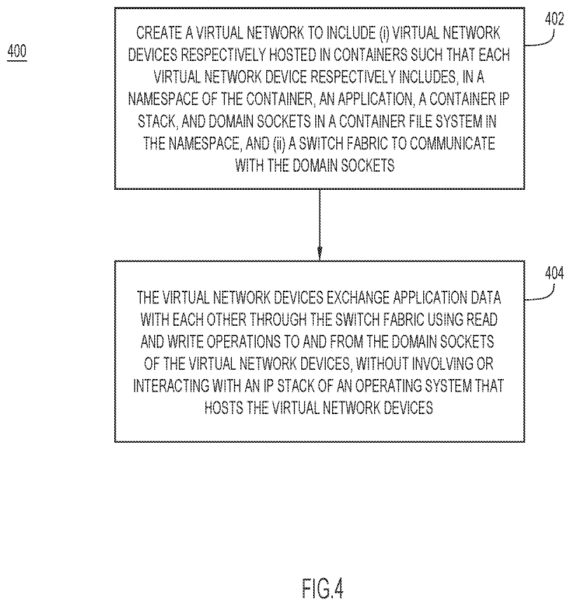

FIG. 4 is a flowchart of an example method 400 of light-weight socket networking of virtual network devices (or functions). Method 400 may be performed by a computer device configured with an operating system (e.g., an OS kernel) that implements an IP stack for communicating with an external network.

At 402, the computer device creates a virtual network to include (i) virtual network devices respectively hosted in containers such that each virtual network device respectively includes, in a namespace of the container, an application, a container IP stack (also referred to as a “virtual IP stack”) that is distinct from the IP stack of the operating system (e.g., the OS kernel), and domain sockets in a container file system in the namespace, and (ii) a switch fabric to communicate with the domain sockets and thus interconnect the virtual network devices. The computer device creates the container file system in the namespace of each container, and creates, in the namespace, the domain sockets. The domain sockets (in each container) include (i) a write domain socket to which processes in each container are able to write first data and from which the switch fabric is able to read the first data, and (ii) a read domain socket to which the switch fabric is able to write second data and from which the processes are able to read the second data. In addition, the container file system may be represented in a directory of a host file system of the operating system (e.g., the OS kernel), such that the directory is accessible to the switch fabric to enable the switch fabric to write to the read domain socket and read from the write domain socket.

At 404, the virtual network devices exchange application data (e.g., user application data as opposed to network control commands or messages/signaling information) with each other through the switch fabric using read and write operations to and from the domain sockets of the virtual network devices, without involving or interacting with the IP stack of the operating system.

An example with two virtual network devices includes:
a. A first virtual network device hosted in a first container that has a first namespace that includes a first application, a first container IP stack, and first domain sockets.
b. A second virtual network device hosted in a second container that has a second namespace that includes a second application, a second container IP stack, and second domain sockets.

In the example with two virtual network devices, the first virtual network device and the second virtual network device exchange application data with each other (e.g., the first and second applications exchange the application data) through the switch fabric using the read and write operations to and from the first domain sockets and the second domain sockets, without involving the IP stack of the operating system. For example, to exchange the application data:
a. The first application sends the application data to the first container IP stack.
b. The first container IP stack encapsulates the application data in a data frame (this may include first encapsulating the application data in an IP packet and second encapsulating the IP packet in the data frame), and writes the data frame to a write domain socket of the first domain sockets.

c. The switch fabric reads the data frame from the write domain socket, and writes the data frame to a read domain socket of the second domain sockets.

d. The second container IP stack reads the data frame from the read domain socket, decapsulates the application data from the data frame (this may include first decapsulating the data frame to recover an IP packet and second decapsulating the IP packet to recover the application data), and provides the application data to the second application.

In summary, embodiments presented herein use Unix domain sockets (UDSs) or other file descriptor-based communication mechanisms to provide network access to virtual network devices/functions running in containers or micro-virtual machines (VMs). The result is lighter-weight internetworking capabilities that can easily interact with other, more traditional, network paradigms. In an example, an internal or inside process (e.g., user application, container IP stack, and so on) in a container reads and writes to a pair of domain sockets, and an external or outside process (e.g., a switch fabric outside of the container) reads and writes to the socket pair, as well. Thus, the pair of domain sockets allows the inside process to communicate with the outside process. Unix domain sockets provide a superior communication interface with the outside world in comparison to existing methods, such as tunnels. In particular, there is no unwanted interference with the inside and outside processes using the domain sockets. That is, only the data frames written into the socket by the sender are received by the receiver (i.e., the process reading from the socket).

In these embodiments, the “inside process” creates a socket in the container and writes data frames to the socket. The inside process expects the “outside process” to read the data frames that are written to the socket, from the socket. The “outside process” accesses the socket inside of the container because the container file system (even though it has its own namespace) is represented on a host file system in a directory that is accessible to the “outside process.” Thus, the outside process reads frames written to the socket by the “inside process.” The “outside process” also writes data frames into a socket that similarly resides inside the container file system and thus is accessible to both the “outside process” and the “inside process.”

In an example, an application such as a network address translation (NAT) gateway may use the above-mentioned UNIX domain sockets (UDSs). In this case, a custom OS kernel interface may include IP sockets that are mapped to UDSs.

In another example, instead of providing multiple virtual bridges if a network function accesses different network segments (e.g., a dynamic host configuration protocol (DHCP) function may want multiple network segments), one UDS can be used and framing is added to domains to differentiate segments. The framing can be added explicitly by a process as part of a data payload or via a new setsockopt API call. For example, with a new SO_INTF socket option that can set a 32-bit interface identifier (ID):
a. Int intf_id=1.
b. Setsockopt(sockfd, SOL_SOCKET, SO_INTF, &intf_id, sizeof(int)).

On a host side, the interface IDs from the sockets may be mapped to the pseudo-network interfaces when the containers are started. Packets from the network function can be interchanged with other on-host network functions via the same UDS construct or routed out to external networks via existing network bridges or virtual ethernet interfaces. Those network functions that do need to communicate between each other (e.g., in a service function chain) can do so without having traffic touch those network interfaces, thus reducing the overall resource impact on the host itself.

Referring to FIG. 5, FIG. 5 illustrates a hardware block diagram of a computing device 500 that may perform functions associated with operations discussed herein in connection with the techniques depicted in FIGS. 1-4. In various embodiments, a computing device or apparatus, such as computing device 500 or any combination of computing devices 500, may be configured as any entity/entities as discussed for the techniques depicted in connection with FIGS. 1-4 in order to perform operations of the various techniques discussed herein. For example, computing device may represent computer device 102, for example.

In at least one embodiment, the computing device 500 may be any apparatus that may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 (wired and/or wireless) to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, any other I/O port(s), and/or antenna(s)/antenna array(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to computing device 500. For example, I/O interface(s) 514 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations (including generating GUIs for display and interacting with the GUIs) in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, domains, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a method including: by a computer device configured with an operating system that implements an Internet Protocol (IP) stack for communicating with an external network, creating a virtual network to include: virtual network devices respectively hosted in containers such that each virtual network device respectively includes an application, a container IP stack, and domain sockets; and a switch fabric to communicate with the domain sockets; and by the virtual network devices, exchanging application data with each other through the switch fabric using read and write operations to and from the domain sockets of the virtual network devices, without involving the IP stack of the operating system.

In some aspects, the techniques described herein relate to a method, wherein the operating system implements the IP stack such that the IP stack is distinct from each container IP stack.

In some aspects, the techniques described herein relate to a method, wherein creating further includes: creating a container file system in a namespace of each container; and creating, in the namespace of the container file system, the domain sockets to include: a write domain socket to which processes in each container are able to write first data and from which the switch fabric is able to read the first data; and a read domain socket to which the switch fabric is able to write second data and from which the processes are able to read the second data.

In some aspects, the techniques described herein relate to a method, wherein: the container file system is represented in a directory of a host file system of the operating system, wherein the directory is accessible to the switch fabric to enable the switch fabric to write to the read domain socket and read from the write domain socket.

In some aspects, the techniques described herein relate to a method, wherein the operating system includes a Linux operating system and the domain sockets include Unix domain sockets.

In some aspects, the techniques described herein relate to a method, wherein creating includes creating the virtual network devices to include: a first virtual network device hosted in a first container and that includes a first application, a first container IP stack, and first domain sockets; and a second virtual network device hosted in a second container and that includes a second application, a second container IP stack, and second domain sockets, wherein exchanging includes, by the first virtual network device and the second virtual network device, exchanging the application data with each other through the switch fabric using the read and write operations to and from the first domain sockets and the second domain sockets, without involving the IP stack of the operating system.

In some aspects, the techniques described herein relate to a method, wherein exchanging further includes: by the first application, sending the application data to the first container IP stack; by the first container IP stack, encapsulating the application data in a data frame, and writing the data frame to a write domain socket of the first domain sockets; and by the switch fabric, reading the data frame from the write domain socket, and writing the data frame to a read domain socket of the second domain sockets.

In some aspects, the techniques described herein relate to a method, wherein exchanging further includes: by the second container IP stack, reading the data frame from the read domain socket, decapsulating the application data from the data frame, and providing the application data to the second application.

In some aspects, the techniques described herein relate to a method, wherein: encapsulating includes first encapsulating the application data in an IP packet and second encapsulating the IP packet in the data frame.

In some aspects, the techniques described herein relate to a method, wherein exchanging further includes: by the switch fabric, writing a data frame that conveys the application data to a read domain socket of the first domain sockets; and by the first container IP stack, reading the data frame from the read domain socket, decapsulating the data frame to recover the application data, and sending the application data to the first application.

In some aspects, the techniques described herein relate to a method, wherein: decapsulating includes first decapsulating the data frame to recover an IP packet and second decapsulating the IP packet to recover the application data.

In some aspects, the techniques described herein relate to a method, wherein the operating system includes a Linux operating system and the domain sockets include Unix domain sockets.

In some aspects, the techniques described herein relate to an apparatus including: a network input/output interface to communicate with a network; and a processor coupled to the network input/output interface and configured to execute an operating system that implements an Internet Protocol (IP) stack for communicating with the network, wherein the processor is configured to create a virtual network to include: virtual network devices hosted in containers such that each virtual network device includes an application, a container IP stack, and domain sockets; and a switch fabric to communicate with the domain sockets, wherein the virtual network devices are configured to exchange application data with each other through the switch fabric using read and write operations to and from the domain sockets, without involving the IP stack of the operating system.

In some aspects, the techniques described herein relate to an apparatus, wherein the operating system is configured to implement the IP stack such that the IP stack is distinct from each container IP stack.

In some aspects, the techniques described herein relate to an apparatus, further including: creating a container file system in a namespace of each container; and creating, in the namespace of the container file system, the domain sockets in each container to include: a write domain socket to which processes in each container are able to write first data and from which the switch fabric is able to read the first data; and a read domain socket to which the switch fabric is able to write second data and from which the processes are able to read the second data.

In some aspects, the techniques described herein relate to an apparatus, wherein: the container file system is represented in a directory of a host file system of the operating system, wherein the directory is accessible to the switch fabric to enable the switch fabric to write to the read domain socket and read from the write domain socket.

In some aspects, the techniques described herein relate to an apparatus, wherein the virtual network includes: a first virtual network device hosted in a first container and that includes a first application, a first container IP stack, and first domain sockets; and a second virtual network device hosted in a second container and that includes a second application, a second container IP stack, and second domain sockets, wherein the first virtual network device and the second virtual network device are configured to exchange the application data with each other through the switch fabric using the read and write operations to and from the first domain sockets and the second domain sockets, without involving the IP stack of the operating system.

In some aspects, the techniques described herein relate to a non-transitory computer readable medium encoded with instructions that, when executed by a processor of a computer device configured with an operating system that implements an Internet Protocol (IP) stack for communicating with an external network, cause the processor to perform: creating a virtual network to include: virtual network devices respectively hosted in containers such that each virtual network device respectively includes an application, a container IP stack, and domain sockets; and a switch fabric to communicate with the domain sockets; and by the virtual network devices, exchanging application data with each other through the switch fabric using read and write operations to and from the domain sockets of the virtual network devices, without involving the IP stack of the operating system.

In some aspects, the techniques described herein relate to a non-transitory computer readable medium, wherein the instructions to cause the processor to perform creating include instructions to cause the processor to perform: creating a container file system in a namespace of each container; and creating, in the namespace of the container file system, the domain sockets to include: a write domain socket to which processes in each container are able to write first data and from which the switch fabric is able to read the first data; and a read domain socket to which the switch fabric is able to write second data and from which the processes are able to read the second data.

In some aspects, the techniques described herein relate to a non-transitory computer readable medium, wherein: the container file system is represented in a directory of a host file system of the operating system, wherein the directory is accessible to the switch fabric to enable the switch fabric to write to the read domain socket and read from the write domain socket.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
by a computer device configured with an operating system that implements an Internet Protocol (IP) stack for communicating with an external network, creating a virtual network to include:
virtual network devices respectively hosted in containers such that each virtual network device respectively includes an application, a container IP stack, and domain sockets; and
a switch fabric to communicate with the domain sockets; and
by the virtual network devices, exchanging application data with each other through the switch fabric using read and write operations to and from the domain sockets of the virtual network devices, without involving the IP stack of the operating system.

2. The method of claim 1, wherein the operating system implements the IP stack such that the IP stack is distinct from each container IP stack.

3. The method of claim 1, wherein creating further includes:
creating a container file system in a namespace of each container; and
creating, in the namespace of the container file system, the domain sockets to include:
a write domain socket to which processes in each container are able to write first data and from which the switch fabric is able to read the first data; and
a read domain socket to which the switch fabric is able to write second data and from which the processes are able to read the second data.

4. The method of claim 3, wherein:
the container file system is represented in a directory of a host file system of the operating system, wherein the directory is accessible to the switch fabric to enable the switch fabric to write to the read domain socket and read from the write domain socket.

5. The method of claim 1, wherein the operating system includes a Linux operating system and the domain sockets include Unix domain sockets.

6. The method of claim 1, wherein creating includes creating the virtual network devices to include:
a first virtual network device hosted in a first container and that includes a first application, a first container IP stack, and first domain sockets; and
a second virtual network device hosted in a second container and that includes a second application, a second container IP stack, and second domain sockets,
wherein exchanging includes, by the first virtual network device and the second virtual network device, exchanging the application data with each other through the switch fabric using the read and write operations to and from the first domain sockets and the second domain sockets, without involving the IP stack of the operating system.

7. The method of claim 6, wherein exchanging further includes:
by the first application, sending the application data to the first container IP stack;
by the first container IP stack, encapsulating the application data in a data frame, and writing the data frame to a write domain socket of the first domain sockets; and
by the switch fabric, reading the data frame from the write domain socket, and writing the data frame to a read domain socket of the second domain sockets.

8. The method of claim 7, wherein exchanging further includes:
by the second container IP stack, reading the data frame from the read domain socket, decapsulating the application data from the data frame, and providing the application data to the second application.

9. The method of claim 7, wherein:
encapsulating includes first encapsulating the application data in an IP packet and second encapsulating the IP packet in the data frame.

10. The method of claim 6, wherein exchanging further includes:
by the switch fabric, writing a data frame that conveys the application data to a read domain socket of the first domain sockets; and
by the first container IP stack, reading the data frame from the read domain socket, decapsulating the data frame to recover the application data, and sending the application data to the first application.

11. The method of claim 10, wherein:
decapsulating includes first decapsulating the data frame to recover an IP packet and second decapsulating the IP packet to recover the application data.

12. The method of claim 1, wherein the operating system includes a Linux operating system and the domain sockets include Unix domain sockets.

13. An apparatus comprising:
a network input/output interface to communicate with a network; and
a processor coupled to the network input/output interface and configured to execute an operating system that implements an Internet Protocol (IP) stack for communicating with the network, wherein the processor is configured to create a virtual network to include:
virtual network devices hosted in containers such that each virtual network device includes an application, a container IP stack, and domain sockets; and
a switch fabric to communicate with the domain sockets,
wherein the virtual network devices are configured to exchange application data with each other through the switch fabric using read and write operations to and from the domain sockets, without involving the IP stack of the operating system.

14. The apparatus of claim 13, wherein the operating system is configured to implement the IP stack such that the IP stack is distinct from each container IP stack.

15. The apparatus of claim 13, further comprising:
creating a container file system in a namespace of each container; and
creating, in the namespace of the container file system, the domain sockets in each container to include:
a write domain socket to which processes in each container are able to write first data and from which the switch fabric is able to read the first data; and
a read domain socket to which the switch fabric is able to write second data and from which the processes are able to read the second data.

16. The apparatus of claim 15, wherein:
the container file system is represented in a directory of a host file system of the operating system, wherein the directory is accessible to the switch fabric to enable the switch fabric to write to the read domain socket and read from the write domain socket.

17. The apparatus of claim 13, wherein the virtual network includes:
a first virtual network device hosted in a first container and that includes a first application, a first container IP stack, and first domain sockets; and
a second virtual network device hosted in a second container and that includes a second application, a second container IP stack, and second domain sockets,
wherein the first virtual network device and the second virtual network device are configured to exchange the application data with each other through the switch fabric using the read and write operations to and from the first domain sockets and the second domain sockets, without involving the IP stack of the operating system.

18. A non-transitory computer readable medium encoded with instructions that, when executed by a processor of a computer device configured with an operating system that implements an Internet Protocol (IP) stack for communicating with an external network, cause the processor to perform:
creating a virtual network to include:
virtual network devices respectively hosted in containers such that each virtual network device respectively includes an application, a container IP stack, and domain sockets; and
a switch fabric to communicate with the domain sockets; and
by the virtual network devices, exchanging application data with each other through the switch fabric using read and write operations to and from the domain sockets of the virtual network devices, without involving the IP stack of the operating system.

19. The non-transitory computer readable medium of claim 18, wherein the instructions to cause the processor to perform creating include instructions to cause the processor to perform:
creating a container file system in a namespace of each container; and
creating, in the namespace of the container file system, the domain sockets to include:
a write domain socket to which processes in each container are able to write first data and from which the switch fabric is able to read the first data; and
a read domain socket to which the switch fabric is able to write second data and from which the processes are able to read the second data.

20. The non-transitory computer readable medium of claim 19, wherein:
the container file system is represented in a directory of a host file system of the operating system, wherein the directory is accessible to the switch fabric to enable the switch fabric to write to the read domain socket and read from the write domain socket.
